(19) United States
(12) Patent Application Publication
(10) Pub. No.: US 2026/0340983 A1
(43) Pub. Date: Oct. 29, 2026

(54) DATA PROCESSING DEVICE DETERMINING CORRESPONDENCES BETWEEN FEATURE POINTS EXTRACTED FROM REFERENCE IMAGE AND FEATURE POINTS EXTRACTED FROM CAPTURED IMAGE

(71) Applicant: BROTHER KOGYO KABUSHIKI KAISHA, Nagoya (JP)

(72) Inventor: Masaya TAKASU, Tokai (JP)

(21) Appl. No.: 19/707,776

(22) Filed: Jun. 15, 2026

Related U.S. Application Data
(63) Continuation of application No. PCT/JP2024/039788, filed on Nov. 8, 2024.

(30) Foreign Application Priority Data
Dec. 19, 2023 (JP) 2023-213713

(51) Int. Cl. G06V 10/75; G06T 11/10; G06V 10/46

(52) U.S. Cl. CPC G06V 10/757; G06T 11/10; G06V 10/46

(57) ABSTRACT

A controller of a data processing device obtains an original image including colored portions and a transparent portion. Each colored portion is a region in which a color material is to be applied in printing. The transparent portion is a region in which no color material is to be applied in the printing. The controller generates a reference image by modifying the original image such that a color value of the transparent portion is set to a color value corresponding to a color of a recording medium. The controller extracts a plurality of reference feature points from the reference image and extracts a plurality of captured-image feature points from a captured image. The captured image is generated by optically capturing an image printed on the recording medium based on the original image. The controller determines correspondences between the plurality of reference feature points and the plurality of captured-image feature points.

### REFERENCE TO RELATED APPLICATIONS

This is a by-pass continuation application of International Application No. PCT/JP 2024/039788 filed on Nov. 8 , 2024 which claims priority from Japanese Patent Application No. 2023-213713 filed on Dec. 19, 2023. The entire contents of the International Application and the priority application are incorporated herein by reference.

### TECHNICAL FIELD

The present disclosure relates to feature point matching among a plurality of images.

### BACKGROUND ART

In various types of processing, feature point matching among a plurality of images may be performed. In a known technique in which a printed matter on a recording medium is inspected, a reference image is compared with a printed image. Here, the reference image is an image input to a printing device and a printed image is an image obtained by reading, with a reading device such as a scanner, printed matter output from the printing device. Edge information included in lines, and characters, in each image is extracted as feature points, and alignment between the reference image and the printed image is performed such that positional correlation among feature points of the reference image and the printed image is maximized.

### SUMMARY

Feature point matching among a plurality of images is not easy, and there is room for improvement.

In view of the foregoing, it is an object of the present disclosure to a technique for performing feature point matching among a plurality of images.

In order to attain the above and other object, the present disclosure provides a non-transitory computer-readable storage medium storing instructions that, when executed by a computer, cause the computer to perform operations comprising: obtaining an original image including one or more colored portions and a transparent portion, each of the one or more colored portions being a region in which a color material is to be applied in printing, the transparent portion being a region in which no color material is to be applied in the printing; generating a reference image by modifying the original image such that a color value of the transparent portion is set to a medium color value corresponding to a color of a recording medium; extracting a plurality of reference feature points from the reference image; extracting a plurality of captured-image feature points from a captured image, the captured image being generated by optically capturing an image printed on the recording medium based on the original image; and determining correspondences between the plurality of reference feature points and the plurality of captured-image feature points.

In the above structure, since the reference image is generated by modifying the original image such that the color value of the transparent portion is set to the medium color value corresponding to the color of the recording medium, the correspondences between the plurality of reference feature points and the plurality of captured-image feature points can be appropriately determined.

According to another aspect, the disclosure provides a non-transitory computer-readable storage medium storing instructions that, when executed by a computer, cause the computer to perform operations comprising: obtaining an original image including one or more colored portions and a transparent portion, each of the one or more colored portions being a region in which a color material is to be applied in printing, the transparent portion being a region in which no color material is to be applied in the printing; generating a reference image by modifying the original image such that an outer portion is added to the original image, the outer portion being connected to the original image, the outer portion being outside the original image, the outer portion including pixels with a medium color value corresponding to a color of a recording medium; extracting a plurality of reference feature points from the reference image; extracting a plurality of captured-image feature points from a captured image, the captured image being generated by optically capturing an image printed on the recording medium based on the original image; and determining correspondences between the plurality of reference feature points and the plurality of captured-image feature points.

In the above structure, since the reference image is generated by adding the outer portion to the original image, and the outer portion includes pixels with the medium color value corresponding to the color of the recording medium, the correspondences between the plurality of reference feature points and the plurality of captured-image feature points can be appropriately determined.

According to another aspect, the disclosure provides a data processing device. The data processing device includes a controller including one or more processors. The controller is configured to perform: obtaining an original image including one or more colored portions and a transparent portion, each of the one or more colored portions being a region in which a color material is to be applied in printing, the transparent portion being a region in which no color material is to be applied in the printing; generating a reference image by modifying the original image such that a color value of the transparent portion is set to a medium color value corresponding to a color of a recording medium; extracting a plurality of reference feature points from the reference image; extracting a plurality of captured-image feature points from a captured image, the captured image being generated by optically capturing an image printed on the recording medium based on the original image; and determining correspondences between the plurality of reference feature points and the plurality of captured-image feature points.

In the above structure, since the reference image is generated by modifying the original image such that the color value of the transparent portion is set to the medium color value corresponding to the color of the recording medium, the correspondences between the plurality of reference feature points and the plurality of captured-image feature points can be appropriately determined.

According to another aspect, the disclosure provides a data processing device. The data processing device includes a controller including one or more processors. The controller is configured to perform: obtaining an original image including one or more colored portions and a transparent portion, each of the one or more colored portions being a region in which a color material is to be applied in printing, the transparent portion being a region in which no color material is to be applied in the printing; generating a reference image by modifying the original image such that an outer portion is added to the original image, the outer portion being connected to the original image, the outer portion being outside the original image, the outer portion including pixels with a medium color value corresponding to a color of a recording medium; extracting a plurality of reference feature points from the reference image; extracting a plurality of captured-image feature points from a captured image, the captured image being generated by optically capturing an image printed on the recording medium based on the original image; and determining correspondences between the plurality of reference feature points and the plurality of captured-image feature points.

In the above structure, since the reference image is generated by adding the outer portion to the original image, and the outer portion includes pixels with the medium color value corresponding to the color of the recording medium, the correspondences between the plurality of reference feature points and the plurality of captured-image feature points can be appropriately determined.

### BRIEF DESCRIPTION OF DRAWINGS

FIG. 1 is an illustration of a data processing device.

FIG. 2 is a perspective view illustrating an example of an image capture device.

FIG. 3A illustrates an example of an image represented by image data for printing.

FIG. 3B illustrates an example of a captured image.

FIG. 4 is a flowchart illustrating an inspection process.

FIG. 5 is a flowchart illustrating an alignment process.

FIG. 6 is a flowchart illustrating a process of defining candidate pairs.

FIG. 7 is a diagram illustrating a bounding rectangle.

FIG. 8A is a flowchart illustrating a process of determining a medium color.

FIG. 8B is an illustration of a three-dimensional histogram.

FIG. 9 illustrates an image processing sequence.

FIGS. 10A-10C illustrate an image processing sequence.

FIG. 11 is a flowchart illustrating a selection process.

FIGS. 12A and 12B illustrate calculation of representative color values.

FIG. 13 illustrates a representation format of a coordinate correspondence relationship.

FIGS. 14A and 14B illustrate difference images.

FIGS. 15A and 15B illustrate an image processing sequence.

FIG. 16A is a part of a flowchart of a process of determining a medium color.

FIG. 16B illustrates a captured image displayed on a display.

FIG. 17A is a part of a flowchart a process of determining a medium color.

FIG. 17B illustrates a target region.

### DESCRIPTION

### A. First Embodiment:

### A1. Device Configuration:

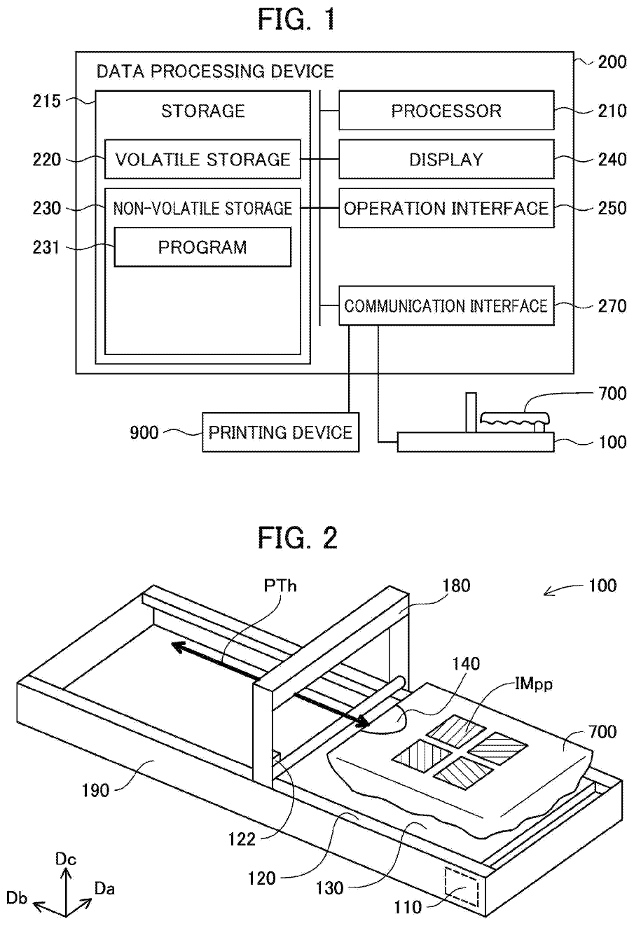

FIG. 1 is an illustration of a data processing device according to an embodiment. A data processing device 200 is, for example, a personal computer. The data processing device 200 executes an inspection process for a printed image. The data processing device 200 includes a processor 210, a storage 215, a display 240, an operation interface 250, and a communication interface 270. These elements are connected to each other via a bus. The storage 215 includes a volatile storage 220 and a non-volatile storage 230.

The processor 210 is a device configured to perform data processing and is, for example, a Central Processing Unit (CPU) or a System on a Chip (SoC). The volatile storage 220 is, for example, a Dynamic Random Access Memory (DRAM), and the non-volatile storage 230 is, for example, a flash memory. The non-volatile storage 230 stores data of a program 231.

The display 240 is a device configured to display an image, such as a liquid crystal display or an organic EL display. The operation interface 250 is a device configured to receive an operation from a user, such as buttons, a lever, or a touch panel arranged to overlap the display 240. The display 240 and the operation interface 250 may be integrated into a so-called touch screen. A user can input various requests and instructions to the data processing device 200 by operating the operation interface 250.

The communication interface 270 is an interface for communicating with another device (for example, including one or more of a USB interface, a wired LAN interface, a wireless interface compliant with IEEE 802.11, and an interface for an industrial camera (for example, Camera Link or CoaXPress)). The communication interface 270 may be a network interface. In the present embodiment, the image capture device 100 and the printing device 900 are connected to the communication interface 270. The printing device 900 is a so-called inkjet printing device and prints an image on a printing medium such as cloth or paper by ejecting ink onto the printing medium. The image capture device 100 generates image data of a read image (captured image) representing an object by optically reading the object, that is, optically capturing an image of the object. Hereinafter, the printing medium is a T-shirt, and the image capture device 100 reads a T-shirt on which an image is printed. The printing medium may be a garment such as an upper-body garment and a lower-body garment. Examples of the upper-body garment includes a shirt, a T-shirt, a blouse, a jacket, a coat, a sweater, a hoodie, and a vest. Examples of the lower-body garment includes a pant, a trouser, a skirt, and a jean.

FIG. 2 is a perspective view illustrating an example of the image capture device 100. In the drawing, a first direction Da and a second direction Db indicate horizontal directions, and a third direction Dc indicates an upward vertical direction. The first direction Da and the second direction Db are perpendicular to each other.

In the present embodiment, the image capture device 100 includes a housing 190, a table 130, a support member 140 fixed to an upper surface of the table 130, a conveyance device 120, an image capture sensor 180, and a control device (controller) 110. The control device 110, the conveyance device 120, and the image capture sensor 180 are fixed to the housing 190.

The support member 140 is a plate-shaped member or a platen defining a flat upper surface for supporting an object to be read. In the drawing, a T-shirt 700 having a printed image IMpp is placed on the support member 140.

The conveyance device 120 is configured to convey the table 130 along an axis parallel to the second direction Db. A configuration of the conveyance device 120 may be varied. Although illustration is omitted, in the present embodiment, the conveyance device 120 includes a rail that supports the table 130 so as to be slidable along the axis parallel to the second direction Db, a plurality of pulleys, a belt wound around the plurality of pulleys and having a portion fixed to the table 130, and an electric motor that rotates the pulleys. When the electric motor rotates the pulleys, the table 130 (and thus the support member 140) moves along the axis parallel to the second direction Db. The conveyance device 120 further includes a position sensor 122 that detects a position of the table 130 on a conveyance path (for example, a rotary encoder).

The image capture sensor 180 is arranged at a position higher than the support member 140 disposed on a conveyance path PTh of the support member 140. The image capture sensor 180 includes a line sensor including a plurality of photoelectric conversion elements arranged in a direction intersecting a conveyance direction Db (in the present embodiment, a direction Da perpendicular to the conveyance direction Db) (for example, a Contact Image Sensor (CIS) or a Charge Coupled Device (CCD)). The image capture sensor 180 faces downward. The image capture sensor 180 can read a portion of an object supported by the support member 140, where the portion is located below the image capture sensor 180.

When the T-shirt 700 is read, the image capture device 100 conveys the table 130 along the axis parallel to the second direction Db. The image capture sensor 180 repeatedly reads the T-shirt 700 during conveyance. Accordingly, the image capture sensor 180 can read an entire portion of the T-shirt 700 supported by the support member 140.

The control device 110 is an electric circuit configured to control the conveyance device 120 and the image capture sensor 180. The control device 110 may include a computer or dedicated hardware (such as an Application Specific Integrated Circuit (ASIC)). The control device 110 generates image data of a read image by controlling the conveyance device 120 and the image capture sensor 180.

### A2. Printing Process

In the present embodiment, an image is printed on a T-shirt 700 (FIG. 2). Printing of the image is performed, for example, as part of a T-shirt sales service. The T-shirt sales service may include on-demand printing. A customer places an order for on-demand printing with a service provider. The service provider prints an image on the T-shirt 700 using image data sent by the customer in accordance with the order.

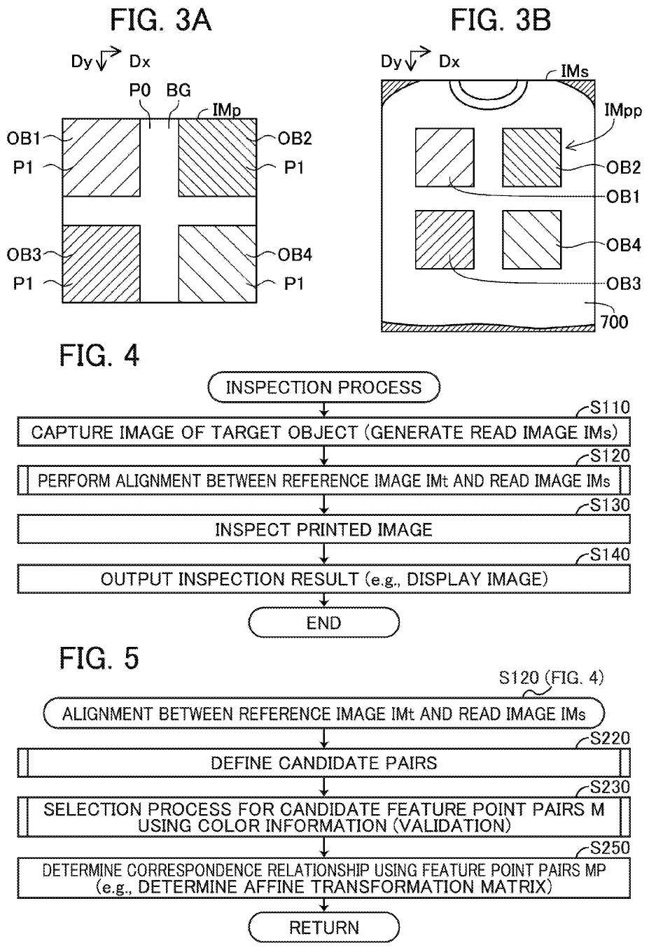

FIG. 3A is a diagram illustrating an example of an image represented by image data for printing (referred to as a target image IMp). The image data for printing is an example of original image data. In the present embodiment, data of the target image IMp is bitmap data representing a color value of each of a plurality of pixels arranged in a matrix in a first direction Dx and a second direction Dy. The color value for each pixel may be gradation values of red R, green G, and blue B with each value ranging from 0 to 255. In the example of FIG. 3A, the target image IMp represents a background BG and four rectangular objects OB1 to OB4. The objects OB1 to OB4 are represented in mutually different colors. For example, a color of the first object OB1 is red, a color of the second object OB2 is green, a color of the third object OB3 is blue, and a color of the fourth object OB4 is gray. As described above, the target image IMp may include a plurality of objects having mutually different hues.

In the present embodiment, the data of the target image IMp further includes an alpha channel representing an opacity of each of the plurality of pixels. In the background BG, the opacity is set to a value indicating transparency. In the present embodiment, a value indicating transparency is used as a value indicating that ink is not used. Hereinafter, a portion indicating that ink is not used in an image is also referred to as a transparent portion. A portion indicating that ink is used in an image is also referred to as a colored portion. The background BG is an example of a transparent portion (referred to as a transparent portion P0). The objects OB1 to OB4 are examples of colored portions (referred to as colored portions P1). Each of the colored portions may be a portion in which color material is applied in printing. The transparent portion may be a portion (colorless portion) in which no color material is applied in printing.

Although illustration is omitted, printing of the target image IMp is performed using the data processing device 200 and the printing device 900. Alternatively, printing of the target image IMp may be performed using another device.

In printing of the target image IMp, various errors may occur. A printed image may have various defects due to such errors. For example, due to an abnormality in ink ejection, missing portions of the image may be present in the printed image. The data processing device 200 detects a defect in the printed image by an inspection process described later. In the present embodiment, the data of the target image IMp is used in the inspection process. After printing of the target image IMp, the data of the target image IMp is stored in the storage 215 (for example, the non-volatile storage 230) of the data processing device 200 for use in the inspection process.

### A3. Inspection Process

FIG. 4 is a flowchart illustrating an example of an inspection process. For inspection, a T-shirt 700 is placed on the support member 140 of the image capture device 100 (FIG. 2) such that a printed image IMpp can face the image capture sensor 180. In the present embodiment, an operator places the T-shirt 700 on the support member 140. Alternatively, a machine (for example, a robot arm) may place the T-shirt 700 on the support member 140. After placement of the T-shirt 700, a start instruction for the inspection process is input to the data processing device 200 (FIG. 1). In the present embodiment, the operator inputs the start instruction for the inspection by operating the operation interface 250. The processor 210 starts the inspection process in response to the start instruction. The start instruction may be input to the data processing device 200 via the communication interface 270 from another device different from the data processing device 200.

The processor 210 of the data processing device 200 executes the inspection process in accordance with the program 231. In S110, the T-shirt 700 is imaged. The processor 210 supplies a reading instruction to the image capture device 100. The control device 110 of the image capture device 100 reads the T-shirt 700 by controlling the image capture sensor 180 and the conveyance device 120 in response to the reading instruction. The control device 110 generates image data of a read image (captured image) representing the T-shirt 700. The processor 210 of the data processing device 200 obtains the image data of the read image from the control device 110 of the image capture device 100 and stores the obtained image data of the read image in the storage 215 (for example, the non-volatile storage 230).

FIG. 3B illustrates an example of a read image. In the present embodiment, the data of the read image IMs is bitmap data representing a color value of each of a plurality of pixels arranged in a matrix in the first direction Dx and the second direction Dy. Here, for each pixel, a color value includes gradation values of red R, green G, and blue B ranging from 0 to 255 for example. The read image IMs in the drawing represents a portion of the T-shirt 700 including the printed image IMpp. Here, the printed image IMpp is an image obtained by printing the target image IMp (FIG. 3A). The printed image IMpp represents the objects OB1 to OB4 similarly to the target image IMp.

In S120 (FIG. 4), the processor 210 performs alignment between a reference image and the read image. In the present embodiment, an image obtained by processing the target image IMp (FIG. 3A) is used as the reference image (details will be described later).

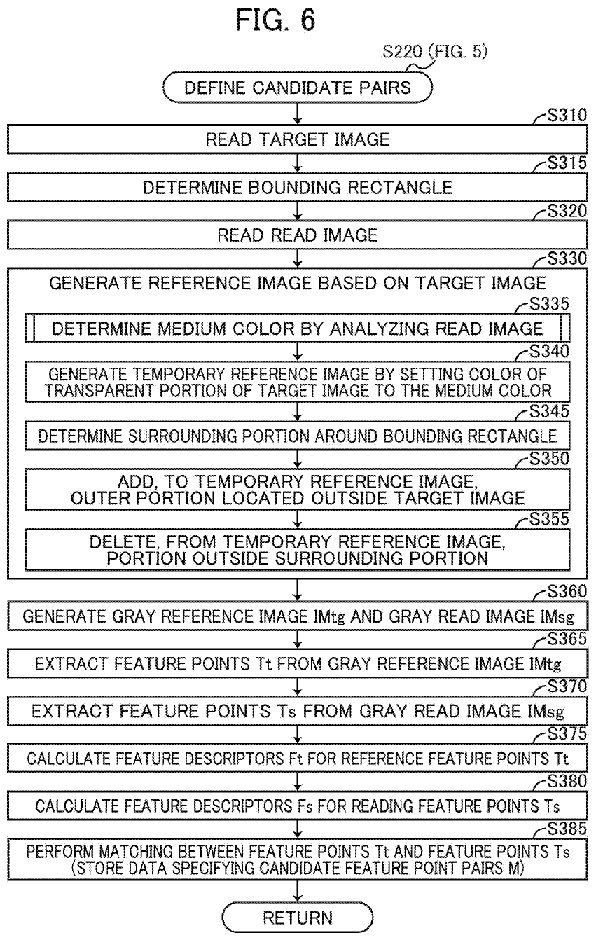

FIG. 5 is a flowchart illustrating an example of an alignment process. In the present embodiment, the processor 210 obtains a plurality of pairs of feature points by feature point matching and determines a correspondence relationship between coordinates on a reference image and coordinates on the read image IMs using the obtained plurality of pairs.

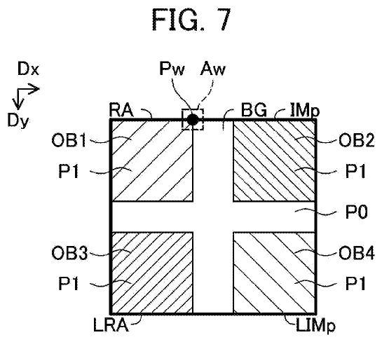

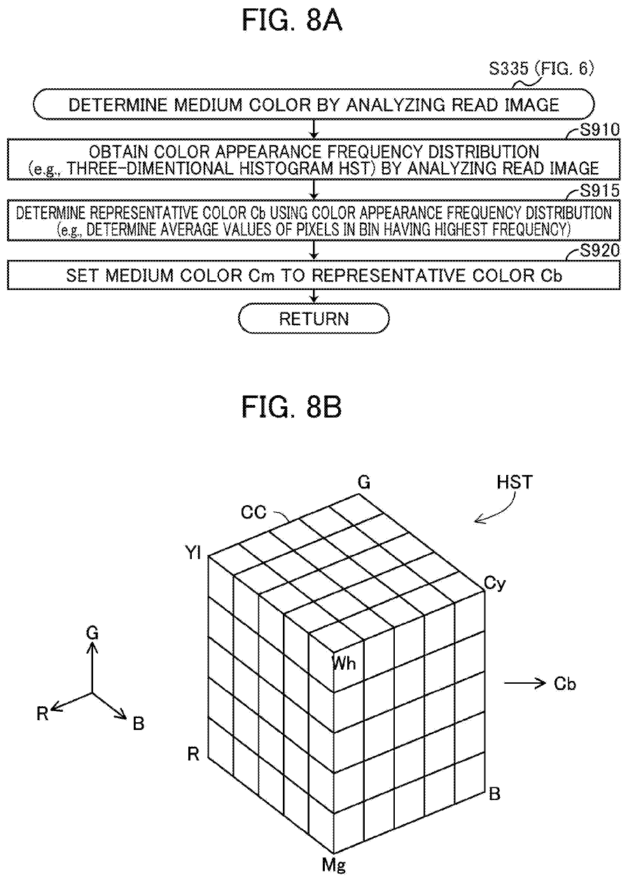

In S220, the processor 210 defines (or generates) candidate pairs that are candidates for feature point pairs. FIG. 6 is a flowchart illustrating an example of a process of defining candidate pairs. In S310, the processor 210 reads image data of the target image IMp (FIG. 3A) used for printing from the storage 215. As described above, the data of the target image IMp is stored in advance in the storage 215 (for example, the non-volatile storage 230).

In S315 (FIG. 6), the processor 210 determines a bounding rectangle that encloses a colored portion P1 of the target image IMp (FIG. 3A). FIG. 7 is a diagram illustrating an example of a bounding rectangle. In the drawing, the target image IMp and a bounding rectangle RA are illustrated. The bounding rectangle RA is a rectangle having two sides parallel to the first direction Dx and two sides parallel to the second direction Dy. The bounding rectangle RA is the smallest rectangle including the colored portion P1 (here, the objects OB1 to OB4). In the target image IMp of FIG. 7, each of the objects OB1 to OB4 defines a part of an edge of the target image IMp. An outline LRA, which is an outline of the bounding rectangle RA, coincides with a target outline LIMp, which is an outline of the target image IMp.

Although illustration is omitted, the bounding rectangle RA varies depending on a position and a shape of the colored portion P1 in the target image IMp. For example, when the colored portion P1 is located inside the target outline LIMp, the bounding rectangle RA is located inside the target outline LIMp.

In S320 (FIG. 6), the processor 210 reads image data of the read image IMs from the storage 215.

In S330, the processor 210 generates image data of a reference image using the data of the target image IMp. As will be described later, feature points are detected from the reference image. Points indicating characteristic portions such as corners and edges of an object are detected as feature points. For example, as shown in FIG. 7, a point Pw indicating an upper-right corner of the first object OB1 is suitable as a feature point. Detection of a feature point uses color values of a plurality of pixels in a region around a candidate point (that is, a partial region including the candidate point). The point Pw is located at an edge of the target image IMp, and therefore an upper portion of a partial region Aw including the point Pw is outside the target outline LIMp. In a case where the feature points are detected from the target image IMp, since color values of pixels outside the target image IMp cannot be referenced, it is difficult to detect the point Pw as a feature point. As described above, when an object is located near an edge of an image, detection of a feature point from a vicinity of the edge of the image is difficult. In the present embodiment, even when an object is located near an edge of the target image IMp, the processor 210 generates a reference image having a surrounding portion outside the bounding rectangle RA such that a feature point can be detected from a vicinity of the edge of the target image IMp.

In the present embodiment, the process of S330 (FIG. 6) includes S335 to S355. In S335, the processor 210 determines a medium color by analyzing the read image IMs. FIG. 8A is a flowchart illustrating an example of a process of determining a medium color. In S910, the processor 210 obtains a color appearance frequency distribution by analyzing the read image IMs. In the present embodiment, the processor 210 generates a three-dimensional histogram HST of RGB.

FIG. 8B is a schematic diagram of the three-dimensional histogram HST. In the drawing, a three-dimensional color solid (color cube) CC represented by three gradation values of red R, green G, and blue B is illustrated. Vertices of the color solid CC are labeled with symbols indicating colors (here, red R, green G, blue B, cyan Cy, magenta Mg, yellow Yl, and white Wh). In the present embodiment, a range of each of the gradation values of red R, green G, and blue B is divided into J bins (J is an integer equal to or greater than 2, for example, J=9). A color value represented by the gradation values of RGB is associated with one of “J * J * J” bins. The processor 210 calculates a frequency for each bin using a plurality of color values of a plurality of pixels of the read image IMs. Accordingly, the processor 210 generates the three-dimensional histogram HST, that is, the color appearance frequency distribution.

In S915 (FIG. 8A), the processor 210 determines a representative color Cb using the three-dimensional histogram HST. In the present embodiment, the processor 210 selects a bin having the highest frequency among a plurality of bins of the three-dimensional histogram HST. The processor 210 calculates, as gradation values of RGB channels of the representative color Cb, mean values of RGB channels of a plurality of color values associated with the bin having the highest frequency in S910. Instead of the mean values, various summary statistics indicating magnitudes of the color values (for example, average values such as a median or a mode) may be used.

In S920, the processor 210 sets the medium color Cm to the representative color Cb. The processor 210 then ends the process of FIG. 8A, that is, S335 of FIG. 6. As will be described later, the medium color Cm is used as a color of a printing medium (here, the T-shirt 700). In the present embodiment, in the read image IMs (FIG. 3B), an area of a blank portion of the T-shirt 700 is larger than an area of a portion representing an object. Here, the blank portion is a portion without a printed image, that is a portion in which no object is arranged. The blank portion may include a portion between objects as well as a peripheral region of the image such as a margin portion. In this case, the representative color Cb approximates the color of the T-shirt 700 in the read image IMs.

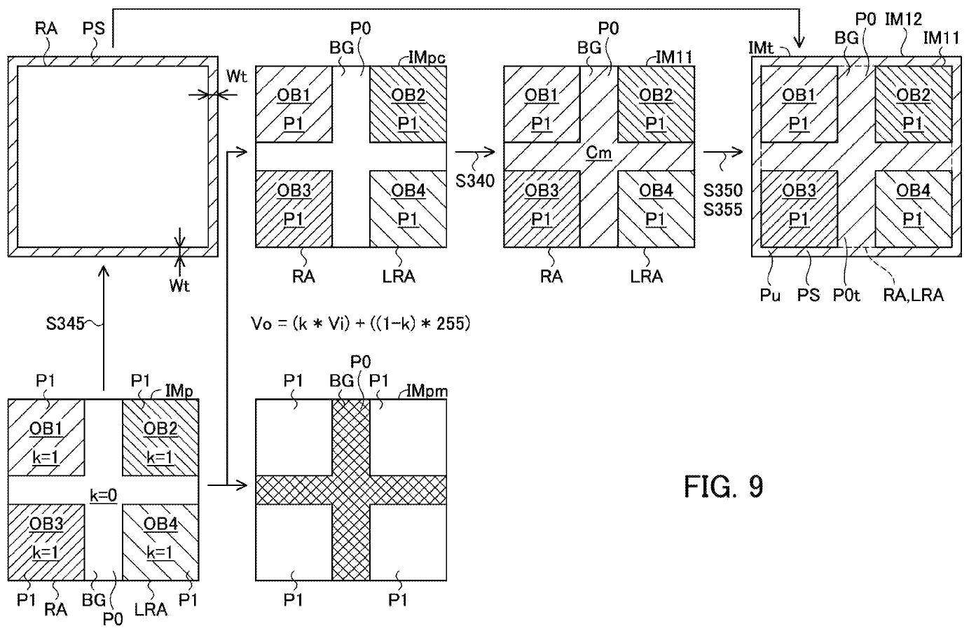

In S340 (FIG. 6), the processor 210 generates image data of a temporary reference image by setting a color of the transparent portion P0 of the target image IMp (FIG. 7) to the medium color Cm. FIG. 9 illustrates an example of images to be processed. In a lower-left portion of FIG. 9, the target image IMp is illustrated. In the present embodiment, the data of the target image IMp is RGB bitmap data having an alpha channel. The processor 210 separates, from the target image IMp, a color image IMpc representing gradation values of RGB channels and a mask image IMpm representing an opacity k of the alpha channel. Here, in a region of the background BG, the opacity k is 0, and in regions of the objects OB1 to OB4, the opacity k is 1. A range of the opacity k is from 0 to 1, where k=0 indicates transparency and k=1 indicates full opacity. In the color image IMpc, the processor 210 temporarily sets each of the R, G, and B values to 255 for a portion where k=0 (that is, the transparent portion P0).

In at least a part of the target image IMp, the opacity k may indicate semi-transparency (here, 0<k<1). In this case, the processor 210 may calculate each gradation value Vo of RGB values of the color image IMpc using the opacity k and an original gradation value Vi. For example, the following calculation expression may be used:

Vo=(k×Vi)+((1−k)×255)

The processor 210 generates image data of a temporary reference image IM11 by setting color values of pixels in the transparent portion P0 of the color image IMpc to the medium color Cm. The image data of the temporary reference image may be generated by replacing the color of the transparent portion P0 of the target image IMp with the medium color Cm.

In S345 (FIG. 6), the processor 210 determines a surrounding portion for surrounding the bounding rectangle RA. In FIG. 9, an example of a surrounding portion PS is illustrated above the target image IMp. In the present embodiment, the processor 210 determines, as the surrounding portion PS, a region having a predetermined width wt surrounding the bounding rectangle RA. In this example, the surrounding portion PS is a rectangular frame having the predetermined width wt as a frame width. The surrounding portion PS is defined as a region in contact with the outer edge of the bounding rectangle RA.

In S350 (FIG. 6), the processor 210 generates image data of a new temporary reference image by adding, to the temporary reference image IM11, an outer portion that is connected to the target image IMp and is located outside the target image IMp within the surrounding portion PS. As shown in an upper-right portion of FIG. 9, an outer portion Pu is added to a temporary reference image IM12. In the example of FIG. 9, an entire surrounding portion PS is located outside the target image IMp. Accordingly, the entire surrounding portion PS coincides with the outer portion Pu. The processor 210 sets color values of the outer portion Pu (here, identical to the surrounding portion PS) to the medium color Cm. In the example of FIG. 9, the outline LRA of the bounding rectangle RA coincides with an outline of the temporary reference image IM11. Accordingly, the surrounding portion PS surrounds the temporary reference image IM11.

In S355, the processor 210 generates image data of a new temporary reference image by deleting, from the temporary reference image IM12, a portion outside the surrounding portion PS. In the example of FIG. 9, since the temporary reference image IM12 does not include a portion outside the surrounding portion PS, a processed temporary reference image resulting from S355 is identical to the temporary reference image IM12. Although illustration is omitted, when the bounding rectangle RA is contained within a region defined by the target outline LIMp (FIG. 7), the surrounding portion PS may be contained within a region defined by an outline of the temporary reference image IM11. In this case, a portion outside the surrounding portion PS in the temporary reference image IM12 is deleted.

Through S335 to S355 described above, image data of a reference image is generated. In the example of FIG. 9, the temporary reference image IM12 is used as the reference image. Hereinafter, the temporary reference image IM12 is also referred to as a reference image IMt.

In S360, the processor 210 generates a gray reference image IMtg and a gray read image IMsg by performing grayscale conversion of the reference image IMt and the read image IMs. As a correspondence relationship between color gradation values and grayscale gradation values, a known relationship can be adopted (for example, a correspondence relationship between RGB values in an RGB color space and a luminance value Y in a YCbCr color space).

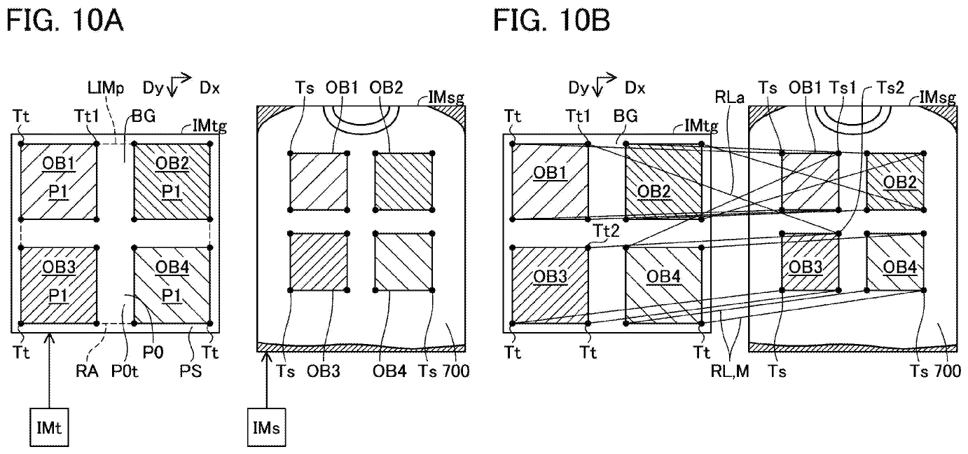

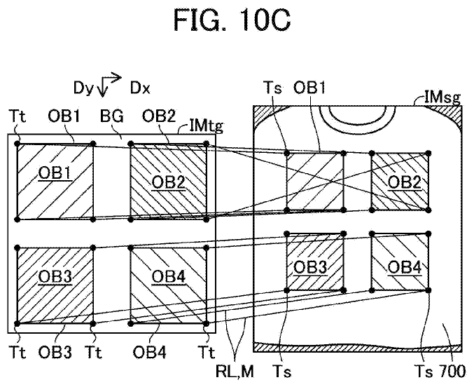

In S365, the processor 210 extracts a plurality of feature points Tt from the gray reference image IMtg. FIGS. 10A to 10C illustrate examples of images to be processed. FIG. 10A illustrates an example of feature points detected from the images IMtg and IMsg. Each black dot on the gray reference image IMtg indicates a feature point Tt detected from the gray reference image IMtg (also referred to as a reference feature point Tt). As illustrated, points indicating characteristic portions such as corners and edges of an object are detected as the feature points Tt. Such feature points Tt are also referred to as key points. Since the surrounding portion PS is added, the reference feature points Tt can also be detected from a vicinity of the target outline LIMp. For example, a reference feature point Tt1 corresponds to the point Pw in FIG. 7. Although illustration is omitted, in practice, a larger number of feature points Tt may be detected (for example, several tens or several hundreds). The reference feature points Tt detected from the gray reference image IMtg correspond to feature points indicating the same portions at the same coordinates on the reference image IMt (FIG. 9).

A method for detecting feature points may be any of various methods. In the present embodiment, a technique referred to as Accelerated-KAZE (A-KAZE), which performs detection of key points and calculation of a feature descriptor for each key point, is used. The A-KAZE technique is disclosed, for example, in the following paper: “Fast Explicit Diffusion for Accelerated Features in Nonlinear Scale Spaces,” Pablo F. Alcantarilla, J. Nuevo, and Adrien Bartoli, in British Machine Vision Conference (BMVC), Bristol, UK, September 2013.

The processor 210 detects the plurality of feature points Tt by analyzing the gray reference image IMtg in accordance with the A-KAZE technique.

In S370 (FIG. 6), the processor 210 extracts a plurality of feature points Ts from the gray read image IMsg. Each black dot on the gray read image IMsg in FIG. 10A indicates a feature point Ts detected from the gray read image IMsg (also referred to as a reading feature point Ts). The processor 210 detects the plurality of feature points Ts by analyzing the gray read image IMsg in accordance with the A-KAZE technique. Although illustration is omitted, in practice, a larger number of feature points Ts may be detected (for example, several tens or several hundreds). The reading feature points Ts detected from the gray read image IMsg correspond to feature points indicating the same portions at the same coordinates on the read image IMs (FIG. 3B).

In S375, the processor 210 calculates a feature descriptor Ft for each of the plurality of reference feature points Tt. The feature descriptor Ft may be any of various types of information describing characteristics of the feature point Tt. The feature descriptor Ft is calculated, for example, so as to vary depending on a distribution of color values of a plurality of pixels around the feature point Tt. In the present embodiment, the processor 210 calculates an A-KAZE feature descriptor as the feature descriptor Ft using the gray reference image IMtg. The feature descriptor may be data that represents a property of a feature point, and may include, without limitation, a multi-dimensional vector, a scalar value, a bit string, or any data structure composed of a combination of the aforementioned elements.

In S380, the processor 210 calculates a feature descriptor Fs for each of the plurality of reading feature points Ts. In the present embodiment, the processor 210 calculates a feature descriptor (that is, the feature descriptor Fs) in accordance with the A-KAZE technique using the gray read image IMsg.

In S385, the processor 210 performs matching between the plurality of reference feature points Tt and the plurality of reading feature points Ts. Through the matching, feature points Tt and Ts indicating mutually similar portions (for example, the same portion of the same object) in the images IMtg and IMsg are associated with each other. A feature point Tt and a feature point Ts associated with each other are also referred to as a matching pair. As will be described later, more appropriate pairs are selected from a plurality of pairs of feature points Tt and Ts defined in S385. Hereinafter, a pair of feature points Tt and Ts finally obtained is referred to as a feature point pair. In other words, in S385, the processor 210 obtains candidates of feature point pairs (also referred to as candidate feature point pairs).

FIG. 10B illustrates an example of candidate feature point pairs. Each line RL in the drawing indicates a candidate feature point pair M. Each line RL connects feature points Tt and Ts included in the candidate feature point pair M. As illustrated, a pair of feature points Tt and Ts indicating the same portion may be selected as the candidate feature point pair M. For example, a feature point Ts2 indicating an upper-right corner of the third object OB3 in the gray read image IMsg may be associated with a feature point Tt2 indicating an upper-right corner of the third object OB3 in the gray reference image IMtg.

A pair of feature points Tt and Ts indicating mutually different portions may also be selected as the candidate feature point pair M. For example, the feature point Ts2 indicating an upper-right corner of the third object OB3 in the gray read image IMsg may be associated with the reference feature point Tt1 indicating an upper-right corner of the first object OB1 in the gray reference image IMtg.

A method of matching may be any of various methods. For example, the processor 210 may associate feature points Tt and Ts having a small distance calculated using the feature descriptors Ft and Fs. The distance is calculated such that a smaller distance indicates a higher similarity between the two feature descriptors Ft and Fs. A method of calculating such a distance may be any of various methods suitable for a data structure of the feature descriptors Ft and Fs. When the feature descriptors Ft and Fs are represented by binary vectors (vectors composed of one or more binary elements), such as an A-KAZE feature descriptor, the processor 210 may use a Hamming distance. Instead of the Hamming distance, the processor 210 may use various other distances (for example, norms such as an L1 norm or an L2 norm (also referred to as a Euclidean distance)). The norms are applicable to various feature descriptors.

The processor 210 associates a reference feature point Tt with a closest reading feature point Ts among a plurality of reading feature points Ts. Alternatively, the processor 210 may associate a reading feature point Ts with a closest reference feature point Tt among a plurality of reference feature points Tt. A method for searching for a closest feature point may be any of various methods. For example, the processor 210 may define a plurality of candidate feature point pairs M by brute-force matching. Alternatively, another method such as FLANN (Fast Library for Approximate Nearest Neighbors)-based matching may be employed.

Here, the processor 210 may execute a process of excluding pairs having low reliability. For example, the processor 210 may sort a plurality of pairs of feature points Tt and Ts in ascending order of distance and select a portion of upper-ranked pairs (for example, 50% of the pairs).

In S385, the processor 210 stores data specifying the plurality of candidate feature point pairs M in the storage 215 (for example, the non-volatile storage 230). The processor 210 then ends the process of FIG. 6, that is, the process of S220 in FIG. 5.

In S230, the processor 210 executes a selection process for candidate feature point pairs using color information. In the selection process, appropriate candidates M are selected from the plurality of candidate feature point pairs M using the color information. That is, the candidate feature point pairs M are validated. In the present embodiment, the plurality of candidate feature point pairs M selected by the process of S230 are used as final feature point pairs.

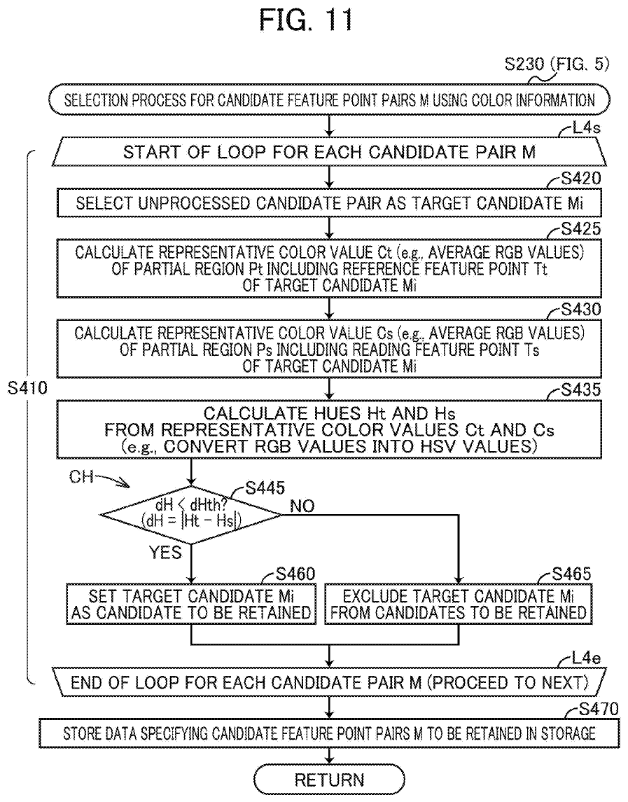

FIG. 11 is a flowchart illustrating an example of the selection process. The processor 210 executes a loop process S410 (including S420 to S465) between a start L4s and an end L4e for each of the plurality of candidate feature point pairs M.

In S420, the processor 210 selects an unprocessed candidate M as a target candidate Mi to be processed.

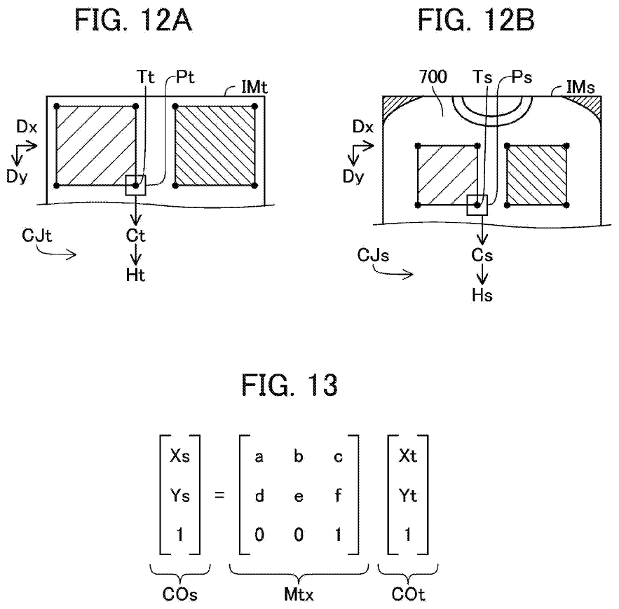

In S425, the processor 210 calculates a representative color value Ct of a first partial region Pt including the reference feature point Tt of the target candidate Mi. The representative color value Ct is also referred to as a reference representative color value Ct. FIGS. 12A and 12B illustrates examples of calculation of representative color values. FIG. 12A illustrates a part of the reference image IMt including the feature point Tt. As shown in the drawing, the first partial region Pt includes the feature point Tt. The processor 210 calculates the reference representative color value Ct using a plurality of color values of a plurality of pixels in the first partial region Pt. A method for calculating the representative color value Ct may be any of various methods for calculating a color representing the first partial region Pt. In the present embodiment, the processor 210 calculates average values such as mean values of red R, green G, and blue B in the first partial region Pt as the representative color value Ct. Instead of the mean values, various summary statistics indicating magnitudes of the color values (for example, a median or a mode) may be used. A configuration of the first partial region Pt (specifically, a shape of the first partial region Pt and a relative position of the first partial region Pt with respect to the feature point Tt) may be any of various configurations capable of calculating the representative color value Ct representing a color of a portion indicated by the feature point Tt. In the present embodiment, the first partial region Pt is a region centered on the feature point Tt and is, for example, a region of P×Q pixels arranged in P rows and Q columns. In order to reduce a dependency of the representative color value Ct on a rotation angle of an object, P=Q may be used (for example, P=Q=5). Instead of a region of P rows and Q columns, the first partial region Pt may be a region in which a distance from the feature point Tt is equal to or less than a distance threshold.

In S430 (FIG. 11), the processor 210 calculates a representative color value Cs of a second partial region Ps including the reading feature point Ts of the target candidate Mi. The representative color value Cs is also referred to as a reading representative color value Cs. FIG. 12B illustrates a part of the read image IMs including the feature point Ts. As shown in the drawing, the second partial region Ps includes the feature point Ts. A configuration of the second partial region Ps is similar to that of the first partial region Pt. The second partial region Ps is a region of P×Q pixels arranged in P rows and Q columns centered on the feature point Ts. A method for calculating the reading representative color value Cs is similar to the method for calculating the reference representative color value Ct. The processor 210 calculates average values such as mean values of red R, green G, and blue B in the second partial region Ps as the reading representative color value Cs.

In S435 (FIG. 11), the processor 210 calculates a first hue Ht from the reference representative color value Ct and calculates a second hue Hs from the reading representative color value Cs. As a correspondence relationship between the representative color value and the hue, a known relationship can be adopted (for example, a correspondence relationship between RGB values in an RGB color space and an H value in an HSV color space). The first hue Ht is an example of a representative color value CJt of the first partial region Pt, similarly to the reference representative color value Ct. The second hue Hs is an example of a representative color value CJs of the second partial region Ps, similarly to the reading representative color value Cs.

In S445, the processor 210 determines whether a hue condition CH is satisfied. The hue condition CH is a condition that an absolute value of a difference between the first hue Ht and the second hue Hs is less than a hue difference threshold dHth. As the absolute value of the difference between the hues Ht and Hs (also referred to as a hue difference dH), a value corresponding to a smaller angular difference between the first hue Ht and the second hue Hs on a hue circle is adopted. When the target candidate Mi is an appropriate pair of feature points Tt and Ts indicating the same portion, the hue difference dH may be small. When the hue difference dH is less than the hue difference threshold dHth (S445: Yes), in S460, the processor 210 selects the target candidate Mi as a candidate to be retained. When the hue difference dH is equal to or greater than the hue difference threshold dHth (S445: No), the hues of the first partial region Pt and the second partial region Ps may be significantly different, and, the feature points Tt and Ts of the target candidate Mi are likely to indicate different portions. In this case, in S465, the processor 210 excludes the target candidate Mi from candidates of feature point pairs. That is, in S465 the target candidate Mi is determined to be excluded from the candidate to be retained.

As described above, the processor 210 excludes, from the candidates, the target candidate Mi having the hue difference dH equal to or greater than the hue difference threshold dHth. FIG. 10C illustrates an example of candidate feature point pairs M that remain after the process of FIG. 11. A pair of feature points Tt and Ts indicating portions having mutually different hues may be excluded. For example, hues of the first object OB1 and the third object OB3 are different from each other. A line RLa shown in FIG. 10B indicates a pair of the reference feature point Tt1 of the first object OB1 and the reading feature point Ts1 of the third object OB3. As illustrated in FIG. 10C, this pair specified by the line RLa is excluded from candidates of feature point pairs (FIG. 11: S445 (No), S465).

As a condition for retaining the target candidate Mi becomes looser, a total number of appropriate candidates M remaining without being excluded may increase. However, a total number of inappropriate candidates may also increase. As the total number of appropriate candidates increases, reliability of processing using a plurality of feature point pairs improves (for example, an error in a coordinate correspondence relationship described later is reduced). When the total number of inappropriate candidates increases, reliability of processing using a plurality of feature point pairs may decrease (for example, an error in the coordinate correspondence relationship may increase). The hue difference threshold dHth (S445) may be experimentally determined in advance such that reliability of processing using a plurality of feature point pairs is acceptable. For example, as the hue difference threshold dHth increases, the condition for retaining the target candidate Mi becomes looser. Even when the target candidate Mi is an appropriate pair of feature points Tt and Ts, the hue difference dH may be greater than 0. A hue difference threshold dHth greater than 0 allows such a hue difference dH. The hue difference threshold dHth may be set to a value greater than 0 and less than a maximum possible value of the hue difference dH.

After S460 or S465, the processor 210 proceeds to S420 to execute the loop process S410 for a next target candidate Mi. When the loop process S410 for all candidates M is completed, in S470, the processor 210 stores data specifying candidate feature point pairs M to be retained in the storage 215 (for example, the non-volatile storage 230). The processor 210 then ends the process of FIG. 11, that is, the process of S230 in FIG. 5. The plurality of candidate feature point pairs M selected by the process of S230 are used as a final plurality of feature point pairs. In the present embodiment, the plurality of feature point pairs are used to determine a coordinate correspondence relationship. As described above, in the present embodiment, the process of feature point matching includes S385 (FIG. 6) and S230 (FIG. 5).

In S250, the processor 210 determines a correspondence relationship between coordinates on the reference image IMt and coordinates on the read image IMs. FIG. 13 illustrates an example of a representation format of the coordinate correspondence relationship. In the drawing, a coordinate COt on the reference image IMt, a coordinate COs on the read image IMs, and a matrix Mtx associating the coordinates COt and COs are illustrated. In the present embodiment, the matrix Mtx represents a so-called affine transformation. The coordinates COt and COs and the matrix Mtx are represented in a homogeneous coordinate system. The coordinates COt are represented by a three-dimensional vector including a position Xt in the first direction Dx on the image IMt, a position Yt in the second direction Dy on the image IMt, and a third component of 1. Similarly, the coordinates COs are represented by a three-dimensional vector including a position Xs in the first direction Dx on the image IMs, a position Ys in the second direction Dy on the image IMs, and a third component of 1. The matrix Mtx is a 3×3 matrix. As illustrated, the matrix Mtx is represented by six parameters “a” to “f” in two rows and three columns, and three components (0, 0, 1) in a third row. Such a matrix Mtx can represent rotation, enlargement, reduction, translation, and skew. The matrix Mtx can be calculated using three or more pairs of the coordinates COt and COs (that is, three or more feature point pairs).

The processor 210 determines the matrix Mtx (here, six parameters “a” to “f”) using a plurality of feature point pairs MP (that is, the plurality of candidate feature point pairs M obtained in S220 and retained in S230 of FIG. 5). A method for determining the matrix Mtx may be any of various methods. For example, the processor 210 may determine the matrix Mtx in accordance with a method referred to as RANdom SAmple Consensus (RANSAC). For determination of the matrix Mtx, for example, a function of OpenCV (Open Source Computer Vision Library) may be used.

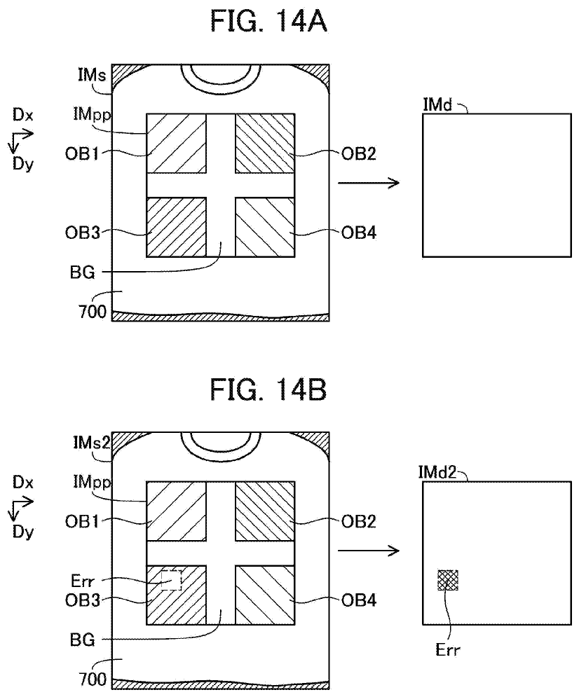

Upon completion of S250 (FIG. 5), the process of FIG. 5, that is, S120 of FIG. 4, ends. In S130, the processor 210 inspects the printed image. A method of inspection may be any of various methods using the coordinate correspondence relationship (FIG. 13). In the present embodiment, the processor 210 generates data of a difference image using the coordinate correspondence relationship. FIGS. 14A and 14B illustrate examples of difference images. FIG. 14A illustrates a case where the printed image has no defect, and FIG. 14B illustrates a case where the printed image has a defect (here, a missing portion Err).

On left sides of FIGS. 14A and 14B, the read images IMs and IMs2, and the printed image IMpp arranged on the read images IMs and IMs2, are illustrated. As described with reference to FIGS. 6 and 9, the reference image IMt includes at least a part of the target image IMp (here, a part including the colored portion P1). A correspondence relationship between a coordinate COt on the reference image IMt and a coordinate on the target image IMp is represented by a translation that associates portions common to the images IMt and IMp. The processor 210 determines a correspondence relationship between a coordinate on the target image IMp and a coordinate COs on the read image IMs (referred to as a target coordinate relationship) using the correspondence relationship of FIG. 13. In FIGS. 14A and 14B, the printed image IMpp is arranged on the read images IMs and IMs2 in accordance with the target coordinate relationship.

Images IMd and IMd2 on right sides of FIGS. 14A and 14B illustrate examples of difference images between the reference image IMt and the read images IMs and IMs2. The processor 210 generates data of the difference images IMd and IMd2 representing differences in color values (for example, absolute values of differences in luminance values) between the read images IMs and IMs2 and the target image IMp at positions associated by the target coordinate relationship. The read image IMs in FIG. 14A represents a printed image without a defect. Accordingly, the difference image IMd does not include a portion indicating a large difference. The read image IMs2 in FIG. 14B represents a printed image having the missing portion Err. Accordingly, in the difference image IMd2, the missing portion Err indicates a larger difference than other portions.

The processor 210 may generate the data of the difference images IMd and IMd2 using the reference image IMt instead of the target image IMp. In this case, a difference in a defect-free portion of the background BG becomes smaller.

In S140 (FIG. 4), the processor 210 outputs an inspection result. A method of outputting the inspection result may be any of various methods. In the present embodiment, the processor 210 displays a difference image on the display 240 (FIG. 1). An operator can easily recognize a defect in the printed image by observing the display 240. Alternatively, the processor 210 may output data representing the inspection result to a storage (for example, the non-volatile storage 230 or an external storage connected to the data processing device 200). Accordingly, the data representing the inspection result is stored in the storage. The data representing the inspection result can be used in various types of processing (for example, an inspection process of an entirety of the T-shirt 700). After S140, the processor 210 ends the inspection process.

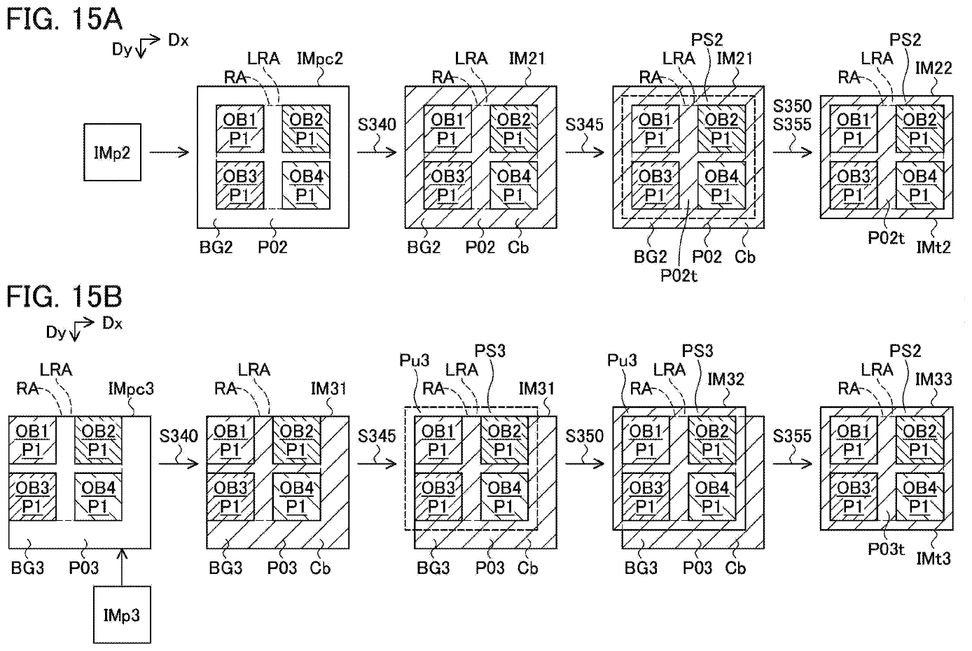

FIGS. 15A and 15B illustrates other examples of images to be processed. FIGS. 15A and 15B show color images IMpc2 and IMpc3 of target images IMp2 and IMp3. The difference from the color image IMpc of FIG. 9 is that backgrounds BG2 and BG3 extend outside the bounding rectangle RA. In regions of the backgrounds BG2 and BG3, the opacity k indicates transparency. Objects OB1-OB4 in the color images IMpc2 and IMpc3 are respectively the same as the objects OB1-OB4 in the color image IMpc of FIG. 9. Even when the target images IMp2 and IMp3 are used, a read image similar to the read image IMs (FIG. 3B) is obtained.

In the color image IMpc2 of FIG. 15A, the background BG2 is configured to surround each of the objects OB1-OB4. In S340 (FIG. 6), the processor 210 generates a temporary reference image IM21 by setting color values of a transparent portion P02 of the color image IMpc2 to the medium color Cm. In S345, the processor 210 determines a surrounding portion PS2 for surrounding the bounding rectangle RA. The surrounding portion PS2 is determined to be contained within a region defined by an outline of the temporary reference image IM21. Therefore, in S350, the region of the temporary reference image IM21 is not extended, but the color in the surrounding portion PS2 is set to have the medium color Cm in the temporary reference image IM21. In S355, the processor 210 generates a temporary reference image IM22 by deleting, from the temporary reference image IM21, a portion outside the surrounding portion PS2. The temporary reference image IM22 is used as a reference image (also referred to as a reference image IMt2).

In the color image IMpc3 of FIG. 15B, the background BG3 includes portions on a first-direction Dx side and a second-direction Dy side of the bounding rectangle RA. In S340 (FIG. 6), the processor 210 generates a temporary reference image IM31 by setting color values of a transparent portion P03 of the color image IMpc3 to the medium color Cm. In S345, the processor 210 determines a surrounding portion PS3 for surrounding the bounding rectangle RA. The surrounding portion PS3 includes an outer portion Pu3 located outside the temporary reference image IM31 (specifically, portions on a-Dx direction side and a-Dy direction side of the temporary reference image IM31). In S350, the processor 210 generates a temporary reference image IM32 by adding, to the temporary reference image IM31, the outer portion Pu3 of the surrounding portion PS3 that is located outside the temporary reference image IM31 and connected to the temporary reference image IM31. The processor 210 sets color values of the outer portion Pu3 to the medium color Cm. In S355, the processor 210 generates a temporary reference image IM33 by deleting, from the temporary reference image IM32, a portion outside the surrounding portion PS3. The temporary reference image IM33 is used as a reference image (also referred to as a reference image IMt3). Thus, the outer portion Pu3 is added to the reference image IMt3.

Thus, the reference images IMt2 and IMt3, similarly to the reference image IMt (FIG. 10A), include the surrounding portions PS2 and PS3 that surround the bounding rectangle RA. Therefore, from the reference images IMt2 and IMt3, appropriate candidate feature point pairs M can be determined from regions in the vicinity of the outline LRA of the bounding rectangle RA, as in the reference image IMt.

Further, when the color images IMpc2 and IMpc3, and thus the target images IMp2 and IMp3, include portions outside the surrounding portions PS2 and PS3, the processor 210 deletes the portions outside the surrounding portions PS2 and PS3 (FIG. 6: S355). Accordingly, since sizes of the reference images IMt2 and IMt3 are reduced, a processing load of processes using the reference images IMt2 and IMt3 (for example, the processes of S360-S385 in FIG. 6) is reduced. For example, a size of a storage area used to store the reference images IMt2 and IMt3 is reduced.

Hereinafter, among transparent portions P0, P02, and P03 of the target images IMp, IMp2, and IMp3 (FIG. 10, FIG. 15A, and 15B), portions included in the reference images IMt, IMt2, and IMt3 are referred to as reference transparent portions P0t, P02t, and P03t.

As described above, in the present embodiment, the processor 210 executes the following processing in accordance with the program 231. In S330 of FIG. 6, the processor 210 executes a generation process of generating a reference image IMt using print image data representing the target image IMp (FIG. 9) (the process of S330 is also referred to as a generation process S330). The reference image IMt includes a reference transparent portion P0t, which corresponds to at least a part of the transparent portion P0 indicating a portion of the target image IMp where no color material is to be applied in printing, and the colored portion P1 indicating a portion of the target image IMp where a color material is to be applied in printing. The generation process S330 includes S340. In S340, the processor 210 sets a color of the transparent portion P0 (including the reference transparent portion P0t) to a medium color Cm, which is a color representing a T-shirt 700 as an example of a medium.

In S385, the processor 210 performs feature point matching using a plurality of feature points Ts in the gray read image IMsg (FIG. 10A) (that is, a plurality of feature points Ts in the read image IMs) and a plurality of feature points Tt in the gray reference image IMtg (FIG. 10A) (that is, a plurality of feature points Tt in the reference image IMt). The read image IMs is an image generated by optically reading the target image IMp printed on the T-shirt 700 using the print image data.

As described above, since the color of the reference transparent portion P0t included in the reference image IMt (FIG. 9) is set to the medium color Cm, the color of the reference transparent portion P0t becomes close to a color of a corresponding portion in the read image IMs. Accordingly, the processor 210 can appropriately perform feature point matching using the reference feature points Tt and the read feature points Ts. The reference feature points Tt are feature points in the gray reference image IMtg (FIG. 10), that is, feature points in the reference image IMt. The read feature points Ts are feature points in the gray read image IMsg, that is, feature points in the read image IMs.

In a conceivable case where the color of the reference transparent portion P0t of the reference image IMt is set to a color unrelated to the medium (here, the T-shirt 700), even when the reference feature point Tt and the read feature point Ts in the vicinity of the reference transparent portion P0t indicate the same portion of the same object, a distance between the feature descriptors Ft and Fs may increase. As a result, a total number of appropriate pairs of the feature points Tt and Ts defined in feature point matching may decrease. In the present embodiment, such a decrease in the total number of appropriate pairs can be reduced.

Further, in the present embodiment, in S335 (FIG. 6), the processor 210 executes a color determination process of determining the medium color Cm by analyzing the read image IMs (the process of S335 is also referred to as a color determination process S335). The processor 210 can reduce a difference between the color of the reference transparent portion P0t of the reference image IMt and the color of a corresponding portion in the read image IMs. Accordingly, the processor 210 can appropriately perform feature point matching using the reference feature points Tt and the read feature points Ts.

Further, in the present embodiment, the color determination process S335 (FIG. 6) includes S910, S915, and S920 of FIG. 8A. In S910, the processor 210 obtains the color appearance frequency distribution (the three-dimensional histogram HST) by analyzing the read image IMs. In S915, the processor 210 determines the representative color Cb using the color appearance frequency distribution. In S920, the processor 210 sets the medium color Cm to the representative color Cb. According to this configuration, the processor 210 can determine the medium color Cm suitable for the read image IMs.

Further, in the present embodiment, in S230 (FIG. 5), the processor 210 selects feature point pairs MP using color information. That is, processing of matching the reference feature points Tt and the read feature points Ts includes S230. The processing of S230 includes S445-S465 of FIG. 11. In S445-S465, the processor 210 selects, as candidates M to be retained, a pair of feature points Tt and Ts using a hue Ht associated with the feature point Tt and a hue Hs associated with the feature point Ts.

Thus, the processing of matching the reference feature points Tt and the read feature points Ts includes processing of determining a correspondence relationship between the feature points Ts in the read image IMs and the feature points Tt in the reference image IMt using the hues Ht and Hs. A color shift may occur between the reference image IMt and the read image IMs at the same portion of the same object. Here, hue has a smaller likelihood of such variation compared with luminance and saturation. By using the hues Ht and Hs, the processor 210 can select appropriate candidate feature point pairs M as the feature point pairs MP.

Further, in the present embodiment, the generation process S330 (FIG. 6) further includes S350. As described with reference to FIG. 9 and FIG. 15B, in S350, the processor 210 adds, to the temporary reference images IM11 and IM31, outer portions Pu and Pu3 that are at least partially outside the color images IMpc and IMpc3 (that is, the target images IMp and IMp3) and that indicate the medium color Cm. In this manner, the processor 210 adds the outer portions Pu and Pu3 to the reference images IMt and IMt3 (the processing of S350 is also referred to as an addition process S350). Accordingly, the processor 210 can select appropriate candidate feature point pairs M from regions in the vicinity of outlines of the target images IMp and IMp3.

Further, in the present embodiment, the reference images IMt, IMt2, and IMt3 (FIG. 9, FIG. 15A, and 15B) include the colored portion P1 and surrounding portions PS, PS2, and PS3 that surround the bounding rectangle RA circumscribing the colored portion P1. The reference images IMt, IMt2, and IMt3 are images that do not include portions outside the surrounding portions PS, PS2, and PS3 of the target images IMp, IMp2, and IMp3 (note that the target image IMp does not include a portion outside the surrounding portion PS).

The generation process S330 (FIG. 6) further includes S345. In S345, the processor 210 determines the surrounding portions PS, PS2, and PS3 using the colored portion P1. As described with reference to FIG. 9 and FIG. 15B, in the addition process S350, the processor 210 adds, to the reference images IMt and IMt3, outer portions Pu and Pu3 of the surrounding portions PS and PS3 that are located outside the target images IMp and IMp3. According to this configuration, the processor 210 can generate an appropriate reference image regardless of a shape and a position of the colored portion in the target image.

Further, in the present embodiment, the processor 210 executes the following processing in accordance with the program 231. In the generation process S330 of FIG. 6, the processor 210 executes a generation process of generating reference images IMt and IMt3 using image data for printing that represents the target images IMp and IMp3 (FIG. 9 and FIG. 15B). The generation process S330 (FIG. 6) further includes an addition process S350. As described with reference to FIG. 9 and FIG. 15B, in the addition process S350, the processor 210 adds, to the reference images IMt and IMt3, outer portions Pu and Pu3 that are outside the bounding rectangles RA and that indicate the medium color Cm.

The reference images IMt and IMt3 are used for defining candidate feature point pairs M (FIG. 10A). From a gray reference image of the reference image IMt3, a plurality of reference feature points Tt are detected, similarly to a plurality of reference feature points Tt on the gray reference image IMtg of the reference image IMt. In S385 (FIG. 6), the processor 210 performs feature point matching using a plurality of feature points Ts in the gray read image IMsg (FIG. 10A) (that is, a plurality of feature points Ts in the read image IMs) and a plurality of feature points Tt in gray reference images of the reference images IMt and IMt3 (that is, a plurality of feature points Tt in the reference images IMt and IMt3). The read image IMs is an image generated by optically reading the target image IMp printed on the T-shirt 700 using the print image data. As described above, even when the target image IMp3 is used, the read image similar to the read image IMs is obtained.

Accordingly, the processor 210 can define appropriate candidate feature point pairs M from regions in the vicinity of outlines of the target images IMp and IMp3. As the total number of appropriate candidate feature point pairs M increases, the total number of appropriate feature point pairs MP increases. As the total number of appropriate feature point pairs MP increases, reliability of processing using the plurality of feature point pairs MP (for example, alignment) is improved.

Here, as described above, since the processor 210 determines the medium color Cm by analyzing the read image IMs in the color determination process S335 (FIG. 6), the processor 210 can appropriately perform feature point matching.

Further, as described above, since the color determination process S335 (FIG. 6) includes S910, S915, and S920 of FIG. 8A, the processor 210 can appropriately identify the medium color Cm of the read image IMs.

Further, as described above, in S230 (FIG. 5), the processor 210 selects appropriate feature point pairs MP using color information. The processing of S230 includes S445-S465 of FIG. 11. The processing of matching the reference feature points Tt and the read feature points Ts includes processing of determining a correspondence relationship between the feature points Ts in the read image IMs and the feature points Tt in the reference image IMt using the hues Ht and Hs. By using the hues Ht and Hs, the processor 210 can select appropriate candidate feature point pairs M as the feature point pairs MP.

### B. Second Embodiment:

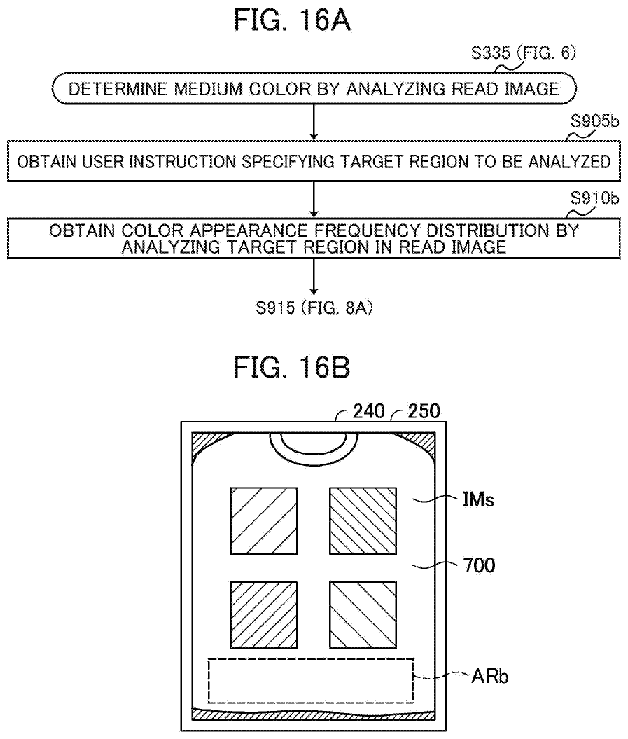

FIG. 16A is a part of a flowchart of another embodiment of processing for determining the medium color Cm (S335 in FIG. 6). A difference from the embodiment of FIG. 8A is that S905b and S910b are executed instead of S910. In the present embodiment, a target region to be analyzed for determining the medium color Cm is specified by a user.

In S905b, the processor 210 obtains a user instruction specifying a target region to be analyzed. In the present embodiment, the processor 210 displays the read image on the display 240 (FIG. 1). FIG. 16B illustrates an example of the read image IMs displayed on the display 240. A user (for example, an operator) can recognize, by observing the displayed read image IMs, a portion representing the T-shirt 700 in the read image IMs (in particular, a blank portion without a printed image).

The user inputs, to the data processing device 200, information indicating a target region ARb representing a blank portion of the T-shirt 700 by operating the operation interface 250. In the present embodiment, the target region ARb is a rectangular region. The user can specify the target region ARb by specifying positions of two vertices defining a diagonal of the rectangle on the read image IMs. The processor 210 obtains the user instruction specifying the target region ARb using information from the operation interface 250. That is, the processor 210 receives an input operation to specify the target region Arb via the operation interface 250.

In S910b (FIG. 16A), the processor 210 obtains a color appearance frequency distribution by analyzing the target region ARb in the read image IMs. In the present embodiment, the processor 210 calculates frequencies of bins of a three-dimensional histogram HST (FIG. 8B) using a plurality of color values of a plurality of pixels in the target region ARb. Portions other than the target region ARb in the read image IMs are not used in the calculation of frequencies.

After S910b, the processor 210 executes S915 and S920 (FIG. 8A). Accordingly, the medium color Cm is determined to be the representative color Cb obtained from the target region ARb. The processor 210 then ends the processing for determining the medium color Cm, that is, S335 of FIG. 6.

As described above, in the present embodiment, the color determination process S335 (FIG. 6) includes S905b (FIG. 16A). In S905b, the processor 210 obtains the user instruction specifying the target region ARb to be analyzed in the read image IMs. As described in S910b, the analysis target of the read image IMs in the color determination process S335 is the target region ARb in the read image IMs. According to this configuration, the processor 210 can determine an appropriate medium color Cm representing the color of the T-shirt 700.

For example, when the target image IMp (FIG. 3A) includes a solid region having a large area, analyzing the entirety of the read image IMs may result in determining a representative color Cb (and thus the medium color Cm) representing the color of the solid region rather than the color of a blank portion, in which no image is printed, of the T-shirt 700. In the present embodiment, a possibility of such an erroneous identification of the medium color can be reduced.

### C. Third Embodiment

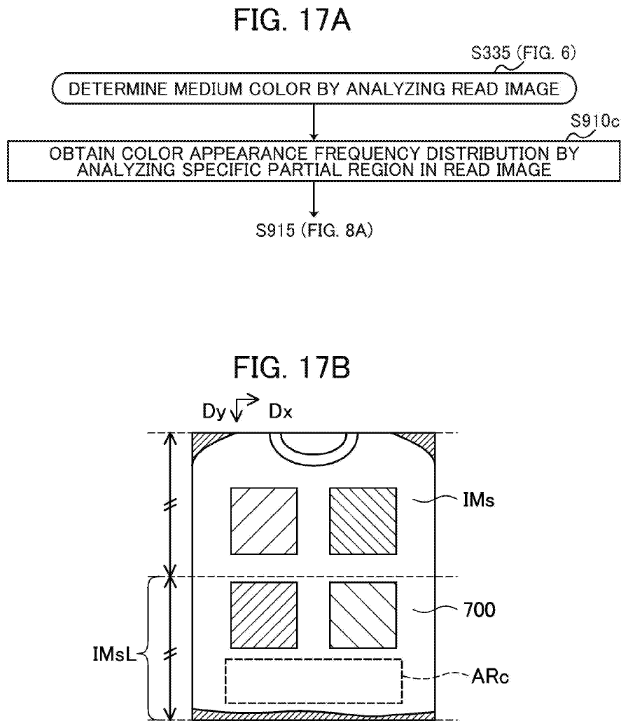

FIG. 17A is a part of a flowchart of another embodiment of processing for determining the medium color Cm (S335 in FIG. 6). A difference from the embodiment of FIG. 8A is that S910c is executed instead of S910. In the present embodiment, a target region in the read image is analyzed to determine the medium color Cm. FIG. 17B illustrates an example of the target region. The read image IMs is shown in the figure. A target region ARc is a specific partial region on a side corresponding to a downward direction of the T-shirt 700 (here, a second direction Dy). That is, the target region ARc is a specific partial region on a side corresponding to a lower side of the T-shirt 700. In the present embodiment, a predetermined region in the read image IMs is used as the target region ARc. In other words, the target region Arc is a prescribed partial region satisfying a specific condition with respect to a direction corresponding to a downward direction of the T-shirt 700 (here, a second direction Dy). The specific condition may be a condition that the target region ARc is a region located farther in a direction (Dy) corresponding to the downward direction of the T-shirt than any of the colored objects (colored portions). The specific condition may be a condition that the target region Arc is within a distal region of the read image IMs, wherein the distal region is a partial region that includes a distal end of the read image IMs toward which the direction (Dy) corresponding to the downward direction of the T-shirt directed. The downward direction of the T-shirt may be a direction from a neck opening toward a hem of the T-shirt. The distal region may be one half of the read image IMs in the direction (Dy) corresponding to the downward direction of the T-shirt.

In S910c, the processor 210 obtains a color appearance frequency distribution by analyzing the target region ARc in the read image IMs. In the present embodiment, the processor 210 calculates frequencies of bins of a three-dimensional histogram HST (FIG. 8B) using a plurality of color values of a plurality of pixels in the target region ARc. Portions other than the target region ARc in the read image IMs are not used in the calculation of frequencies.

After S910c, the processor 210 executes S915 and S920 (FIG. 8A). Accordingly, the medium color Cm is determined to be the representative color Cb obtained from the target region ARc. The processor 210 then ends the processing for determining the medium color Cm, that is, S335 of FIG. 6.

As described above, in the present embodiment, the print medium is the T-shirt 700. A portion of the T-shirt 700 on which an image is printed may be a portion on an upper side of the T-shirt 700 (for example, a portion corresponding to a chest). A portion on a lower side of the T-shirt 700 may be a blank portion where no image is printed. The analysis target of the read image IMs (FIG. 17B) in the color determination process S335 (FIG. 6) is the target region ARc. The target region ARc is a specific partial region on a side corresponding to a downward direction of the T-shirt 700 (here, the second direction Dy) in the read image IMs. Such a target region ARc is likely to represent a blank portion of the T-shirt 700. Accordingly, the processor 210 can identify an appropriate medium color Cm representing the color of the T-shirt 700. For example, even when the target image IMp (FIG. 3A) includes a solid region having a large area, the processor 210 can determine the representative color Cb (and thus the medium color Cm) representing the color of the blank portion of the T-shirt 700.

### D. Modifications

(1) In the embodiment of FIG. 16A, a method of specifying the target region in the read image is not limited to the method of specifying positions of vertices of the target region ARb, and various other methods may be used. For example, the processor 210 may adopt, as the target region, a region surrounded by an outline freely drawn by a user (such selection of a region is also referred to as freehand selection). Alternatively, the processor 210 may select, as the target region, a partial region that includes a designated point on the read image specified by the user and that has a color similar to a color of the designated point (selection of a region using a designated point is also referred to as a magic wand tool).

(2) In the embodiment of FIGS. 17A and 17B, the target region ARc in the read image may be various partial regions on a side corresponding to a downward direction of the T-shirt 700 in the read image IMs (here, the second direction Dy). That is, the specific condition to define the target region Arc may be varied. Hereinafter, the direction in the read image IMs corresponding to the downward direction of the T-shirt 700 is also referred to as a medium downward direction. The target region ARc may be, for example, a partial region included in a lower half region IMsL with respect to the medium downward direction Dy in the read image IMs. Thus, the target region ARc has half of a length in the medium downward direction Dy in the read image IMs.

(3) A method of determining the medium color Cm is not limited to the methods of FIGS. 8A, 8B, 16A, 16B, 17A, and 17B, and various methods for determining the medium color by analyzing the read image may be used. For example, a reference color may be preliminarily associated with each of a plurality of bins of the three-dimensional histogram HST (for example, a color corresponding to an average (a median, a mode, or a mean) of a color value range of each bin). The processor 210 may then adopt, as the representative color Cb, the reference color associated with the bin having the highest frequency.

Further, the processor 210 may use a trained machine learning model (for example, a model that performs region segmentation called instance segmentation, such as Mask R-CNN) to divide, in the read image, a region representing a medium (here, the T-shirt 700) into a region representing a printed image and another region such as a non-printed region (referred to as a blank region). The processor 210 may then determine the medium color Cm by analyzing the blank region. Here, the processor 210 may calculate, as the medium color Cm, a summary statistic (for example, a median, a mode, or a mean) representing a plurality of color values of a plurality of pixels included in the blank region.

Further, the medium color Cm may be determined without using the read image. For example, data representing a correspondence relationship between identification information of a medium (for example, a model number of the medium) and the medium color Cm may be stored in advance in the storage 215 (for example, the non-volatile storage 230). The processor 210 may adopt the medium color Cm corresponding to the identification information of the medium input by the user. Alternatively, the processor 210 may adopt, as the medium color Cm, a color specified by the user (for example, RGB gradation values).

(4) A method of specifying a transparent portion indicating a portion of the target image where no color material is used is not limited to the method using the opacity k of an alpha channel, and any other method may be used. For example, a portion used as the transparent portion in the target image may be a portion having a specific color (for example, white).

(5) The generation process for generating a reference image using the target image is not limited to the generation process S330 of FIG. 6, and various other processes may be used. For example, S350 may be executed after S355. A process of deleting a portion outside a surrounding portion from the reference image (for example, S355) may be omitted. A process of setting a color of a reference transparent portion to a medium color representing a medium (for example, S340) may be omitted. The processor 210 may set the color of the transparent portion to a predetermined color (for example, white).

An addition process of adding, to the reference image, an outer portion outside the target image and indicating the medium color (for example, S350) may be omitted. A process of adding, to the reference image, a surrounding portion that surrounds a bounding rectangle circumscribing a colored portion (for example, S345 and S350) may be omitted. The processor 210 may generate a reference image including the target image and a surrounding portion surrounding the target image. In any case, the target image may be an image that does not include a transparent portion. Even in such a case, when the reference image includes a surrounding portion surrounding the target image, the processor 210 can define appropriate pairs from regions in the vicinity of edges of the reference image.

(6) In S425 and S435 (FIG. 11), the processor 210 may calculate the first hue Ht using the target image instead of the reference image. When the target image includes a transparent portion, the processor 210 may calculate the first hue Ht using a remaining portion obtained by excluding the transparent portion from the target image. The processing of selecting appropriate candidate feature point pairs M using color information (for example, S230 (FIG. 5)) may be omitted.

(7) A method of detecting feature points Tt and Ts (that is, keypoints) is not limited to the methods described in S365 and S370 (FIG. 6), and various methods for detecting points indicating portions of an object in an image may be used. The detection method may be selected in advance from, for example, a search for extrema (including local and global maxima and minima) using DoG (Difference of Gaussian), Harris corner detection, FAST (Features from Accelerated Segment Test) corner detection, SIFT (Scale-Invariant Feature Transform), SURF (Speeded-Up Robust Features), and ORB (Oriented FAST and Rotated BRIEF).

A method of calculating feature descriptors Ft and Fs is not limited to the methods described in S375 and S380 (FIG. 6), and various methods for calculating information describing characteristics of keypoints may be used. An algorithm for calculating feature descriptors may be selected in advance from, for example, BRIEF (Binary Robust Independent Elementary Features), BRISK (Binary Robust Invariant Scalable Keypoints), SIFT, SURF, ORB, KAZE, and A-KAZE.

Further, a method of calculating a distance between the feature descriptors Ft and Fs may be any of various methods suitable for a data structure of the feature amounts Ft and Fs. When the feature amounts Ft and Fs are represented by binary vectors, the distance may be a Hamming distance. Alternatively, instead of the Hamming distance, various other distances may be used (for example, norms such as an L1 norm or an L2 norm (also referred to as a Euclidean distance)). Such norms are applicable to various feature descriptors.

(8) In addition to the process of defining pairs of read feature points Ts in the read image IMs and reference feature points Tt in the reference image IMt (for example, S385 (FIG. 6)), the feature point matching process executed in accordance with the program 231 may include the process of detecting a plurality of reference feature points Tt from the reference image IMt (for example, S365), the process of detecting a plurality of read feature points Ts from the read image IMs (for example, S370), the process of calculating a feature descriptor Ft for each of the plurality of reference feature points Tt (for example, S375), and the process of calculating a feature descriptor Fs for each of the plurality of read feature points Ts (for example, S380).

Processes other than a generation process of generating a reference image using print image data representing the target image and the feature point matching process using a plurality of feature points in the read image and a plurality of feature points in the reference image may be executed in accordance with programs other than the program 231. For example, S250 (FIG. 5) may be executed in accordance with another program. S130 and S140 (FIG. 4) may be executed in accordance with another program. Processes other than the generation process and the feature point matching process may be performed by a device other than the data processing device 200.

The generation process may include one or both of a process of setting a color of a reference transparent portion to a medium color representing a medium and an addition process of adding, to the reference image, an outer portion outside the target image and indicating the medium color representing the medium. In any cases, images processed may be grayscale images instead of color images.

(9) The print medium is not limited to the T-shirt 700 and may be various types of clothing (for example, various shirts such as polo shirts, coats, and slacks). The print medium may be various types of fabric, such as clothing or bags. The print medium is not limited to fabric and may be various media such as paper, film, and leather. Further, the printing device 900 is not limited to an inkjet printing device and may be a printing device of another type (for example, a laser-type printing device).

(10) Results of feature point matching are not limited to being used for determination of a correspondence relationship of coordinates and may be used in various types of processing. For example, when a printed image has a defect, a total number of feature point pairs MP determined by feature point matching may decrease. The total number of feature point pairs MP may be used for evaluation of quality of the printed image (the larger the total number of feature point pairs MP, the higher the quality).

(11) The correspondence relationship of coordinates (FIG. 13) is not limited to an affine transformation and may represent various transformations such as a homography transformation. Further, the correspondence relationship of coordinates may be represented in various formats such as a lookup table instead of the matrix Mtx. The correspondence relationship of coordinates is not limited to being used for inspection and may be used in various types of processing. For example, when a single image is generated by compositing a target image and a read image, the correspondence relationship of coordinates may be used for alignment between the target image and the read image.

(12) The data processing device that performs the generation process and the feature point matching process is not limited to a personal computer (for example, the data processing device 200 (FIG. 1)) and may be various other devices (for example, a smartphone, a tablet computer, and a control device incorporated in an image capture device). Further, a plurality of devices (for example, computers) that can communicate with each other via a network may share functions of data processing performed by the data processing device, thereby performing the data processing function as a whole (a system including these devices corresponds to the data processing device).

In each of the above embodiments, a part of a configuration implemented by hardware may be replaced with software, and conversely, a part or all of a configuration implemented by software may be replaced with hardware. For example, the processing of S385 in FIG. 6 may be executed by a dedicated hardware circuit such as an Application Specific Integrated Circuit (ASIC).

Further, when part or all of the functions of the present disclosure are implemented by a computer program, the program may be stored in a computer-readable recording medium (for example, a non-transitory recording medium). The program may be used in a state stored in the same or a different recording medium (computer-readable recording medium) from that at the time of provision. The “computer-readable recording medium” is not limited to portable recording media such as a memory card or a CD-ROM, and may include internal storages in a computer, such as various types of ROM, and external storages connected to a computer, such as a hard disk drive.

The term “processor” encompasses both a single processor or a group of multiple processors located either locally or remotely working together or in a distributed fashion to collectively perform the tasks attributed to the “processor” described herein.

While the present disclosure has been described in conjunction with various exemplary embodiments illustrated in the drawings, it will be understood by those of ordinary skill in the art that numerous alternatives, modifications, variations, improvements, and substantial equivalents, whether presently known or later developed, may be made without departing from the spirit and scope of the disclosure. The embodiments and modifications are described for purposes of illustration and to facilitate understanding of the present disclosure, and are not intended to be limiting. Accordingly, the present disclosure encompasses all such alternatives, modifications, variations, improvements, combinations of these, and substantial equivalents. Furthermore, the various embodiments and modifications described may be combined in any suitable manner. Some specific examples of possible alternatives, modifications, and variations have been described; however, these examples are not exhaustive.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A non-transitory computer-readable storage medium storing instructions that, when executed by a computer, cause the computer to perform operations comprising:
obtaining an original image including one or more colored portions and a transparent portion, each of the one or more colored portions being a region in which a color material is to be applied in printing, the transparent portion being a region in which no color material is to be applied in the printing;
generating a reference image by modifying the original image such that a color value of the transparent portion is set to a medium color value corresponding to a color of a recording medium;
extracting a plurality of reference feature points from the reference image;
extracting a plurality of captured-image feature points from a captured image, the captured image being generated by optically capturing an image printed on the recording medium based on the original image; and
determining correspondences between the plurality of reference feature points and the plurality of captured-image feature points.

2. The non-transitory computer-readable storage medium according to claim 1,
wherein the operations further comprise:
identifying the medium color value by analyzing the captured image.

3. The non-transitory computer-readable storage medium according to claim 2,
wherein the identifying includes:
obtaining a frequency distribution of color values in the captured image;
determining a representative color value based on the frequency distribution; and
setting the medium color value to the representative color value.

4. The non-transitory computer-readable storage medium according to claim 2,
wherein the identifying includes:
receiving an input operation to specify a target region in the captured image; and
determining a representative color value based on color values in the target region; and
setting the medium color value to the representative color value.

5. The non-transitory computer-readable storage medium according to claim 2,
wherein the recording medium is a T-shirt,
wherein the identifying includes:
determining a representative color value based on color values in a target region, the target region being a partial region of the captured image, the target region being located, in a target direction, farther than any colored portion in the captured image, the target direction corresponding to a downward direction of the T-shirt; and
setting the medium color value to the representative color value.

6. The non-transitory computer-readable storage medium according to claim 1,
wherein the determining is performed based on hue values of the plurality of reference feature points and hue values of the plurality of captured-image feature points.

7. The non-transitory computer-readable storage medium according to claim 1,
wherein the generating the reference image further includes:
generating an intermediate image by adding an outer portion to the original image, the outer portion being connected to the original image, the outer portion being outside the original image, the outer portion including pixels with the medium color value,
wherein the reference image is generated based on the intermediate image.

8. The non-transitory computer-readable storage medium according to claim 7,
wherein the generating the reference image further includes:
identifying a bounding rectangle of the one or more colored portions in the original image; and
defining a surrounding region surrounding the bounding rectangle,
wherein in the adding, the outer portion is added to the original image within the surrounding region.

9. The non-transitory computer-readable storage medium according to claim 1,
wherein the operations further comprise:
generating, based on the correspondences, a difference image between the reference image and the captured image; and
outputting the difference image.

10. A non-transitory computer-readable storage medium storing instructions that, when executed by a computer, cause the computer to perform operations comprising:
obtaining an original image including one or more colored portions and a transparent portion, each of the one or more colored portions being a region in which a color material is to be applied in printing, the transparent portion being a region in which no color material is to be applied in the printing;
generating a reference image by modifying the original image such that an outer portion is added to the original image, the outer portion being connected to the original image, the outer portion being outside the original image, the outer portion including pixels with a medium color value corresponding to a color of a recording medium;
extracting a plurality of reference feature points from the reference image;
extracting a plurality of captured-image feature points from a captured image, the captured image being generated by optically capturing an image printed on the recording medium based on the original image; and
determining correspondences between the plurality of reference feature points and the plurality of captured-image feature points.

11. The non-transitory computer-readable storage medium according to claim 10,
wherein the operations further comprise:
identifying the medium color value by analyzing the captured image.

12. The non-transitory computer-readable storage medium according to claim 11,
wherein the identifying includes:
obtaining a frequency distribution of color values in the captured image;
determining a representative color value based on the frequency distribution; and
setting the medium color value to the representative color value.

13. The non-transitory computer-readable storage medium according to claim 11,
wherein the identifying includes:
receiving an input operation to specify a target region in the captured image; and
determining a representative color value based on color values in the target region; and
setting the medium color value to the representative color value.

14. The non-transitory computer-readable storage medium according to claim 11,
wherein the recording medium is a T-shirt,
wherein the identifying includes:
determining a representative color value based on color values in a target region, the target region being a partial region of the captured image, the target region being located, in a target direction, farther than any colored portion in the captured image, the target direction corresponding to a downward direction of the T-shirt; and
setting the medium color value to the representative color value.

15. The non-transitory computer-readable storage medium according to claim 10,
wherein the determining is performed based on hue values of the plurality of reference feature points and hue values of the plurality of captured-image feature points.

16. A data processing device comprising:
a controller including one or more processors, the controller being configured to perform:
obtaining an original image including one or more colored portions and a transparent portion, each of the one or more colored portions being a region in which a color material is to be applied in printing, the transparent portion being a region in which no color material is to be applied in the printing;
generating a reference image by modifying the original image such that a color value of the transparent portion is set to a medium color value corresponding to a color of a recording medium;
extracting a plurality of reference feature points from the reference image;
extracting a plurality of captured-image feature points from a captured image, the captured image being generated by optically capturing an image printed on the recording medium based on the original image; and
determining correspondences between the plurality of reference feature points and the plurality of captured-image feature points.

17. A data processing device comprising:
a controller including one or more processors, the controller being configured to perform:
obtaining an original image including one or more colored portions and a transparent portion, each of the one or more colored portions being a region in which a color material is to be applied in printing, the transparent portion being a region in which no color material is to be applied in the printing;
generating a reference image by modifying the original image such that an outer portion is added to the original image, the outer portion being connected to the original image, the outer portion being outside the original image, the outer portion including pixels with a medium color value corresponding to a color of a recording medium;
extracting a plurality of reference feature points from the reference image;
extracting a plurality of captured-image feature points from a captured image, the captured image being generated by optically capturing an image printed on the recording medium based on the original image; and
determining correspondences between the plurality of reference feature points and the plurality of captured-image feature points.
